(19) United States
(12) Patent Application Publication
(10) Pub. No.: US 2018/0343792 A1
(43) Pub. Date: Dec. 6, 2018

(54) Horizontal Rotary Product Distributor For Granular Fertilizer Application System

(71) Applicant: CNH Industrial Canada, Ltd., Saskatoon (CA)

(72) Inventors: Martin J. Roberge, Saskatoon (CA); Joel Denis, Saskatoon (CA); Rex L. Ruppert, Benson, MN (US)

(21) Appl. No.: 15/613,945

(22) Filed: Jun. 5, 2017

(51) Int. Cl. A01C 17/00; A01C 15/00; A01C 15/04; A01C 19/02

(52) U.S. Cl. CPC A01C 17/008; A01C 15/008; A01C 19/02; A01C 17/003; A01C 15/04

(57) ABSTRACT

The present invention is directed to an applicator having an agricultural product pneumatic conveying system which meters and transfers particulate material from one or more source containers to application equipment on demand. The pneumatic conveying system employs supply lines connected between the source containers and delivery nozzles that operate to move and mix the particulate material from one of the source containers or tanks. A rotary distributor is connected between each of the supply lines and the delivery nozzles and includes a rotating shaft to divert the particulate material relatively evenly between the delivery nozzles. The rotary distributor is disposed in alignment with the supply line to require less air flow for the distribution of the particulate material into the delivery nozzles and to significantly reduce the profile of the applicator in the folded or transport configuration.

### FIELD OF THE DISCLOSURE

The present invention relates generally to agricultural equipment, and, more particularly, to an agricultural product delivery system on an application implement, such as a planter or fertilizer application equipment, for applying particulate material such as seed, fertilizer, herbicide or insecticide in a field, either as a surface application or deposited in the soil to improve soil quality.

### BACKGROUND OF THE DISCLOSURE

Agricultural product delivery systems are known to utilize various mechanisms, including mechanical and pneumatic systems, i.e., a flow of air, to assist in the delivery and movement of particulate material or product such as fertilizer, seed, insecticide or herbicide from a product supply chamber through an interior passage provided by a series of elongate tubes which extend from the product supply chamber to a product applicator that places the product on or in growing medium, such as soil. Such agricultural product delivery systems are commonly employed in planters, air drills, fertilizer and pesticide applicators and a variety of other agricultural implements.

Agricultural implements that employ an agricultural product delivery system are known to have a particulate material supply source such as one or more tanks that are loaded with the particulate material or materials to be applied. The tanks have or are associated with a metering device, which typically consists of a rotating element, which meters the particulate materials from the tanks into a set of distribution channels, such as conduits, hoses, etc., for application to the farm field. In most systems, a pneumatic source such as a fan or blower provides air to convey and distribute material through the distribution channels. Once the metering of particulates is done and the mix of air and particulates is in the distribution channels, the solid concentration should remain nearly constant and in dilute phase.

Systems as described have provided certain advantages and have worked acceptably in some aspects, but are not without disadvantages, inefficiencies or inconveniences. For example, it is very challenging to transport particles/particulate material, such as seeds and/or fertilizer, through long hoses of fertilizer application equipment and air seeders at an acceptable pressure drop and air flow rate. In particular, the particulate material/product must also be moved in an upward direction or vertically into a dimple tube and headers, or vertical static distributors, to create a vertical homogeneous particulate flow that can then be distributed through multiple smaller individual hoses to the delivery nozzles. While this structure and associated method has been used for decades, the main disadvantages with it are the need to use multiple hoses on the air cart for each tube and header, as this structure requires a significant volume of high pressure air flow, and the multiplicity of vertical headers that often create physical interference with other portions of the equipment upon folding. In addition, the multiple small tubes hanging from the headers create a structural stress on the headers and the headers and small tubes are not designed for large throughput of particulate material, e.g., seeds and/or fertilizer, at high targeted application rates.

What is needed in the art is a pneumatic agricultural product conveying system which improves efficiency by reducing the air flow rate necessary to move the particulate material while also altering the position on the system at which the particulate matter is separated for distribution to the individual nozzles to improve the compactness of the system and associated implement.

### SUMMARY OF THE DISCLOSURE

According to one aspect of the present disclosure, an applicator or similar agricultural implement includes an agricultural product pneumatic conveying system which transfers particulate material from one or more source containers to application equipment on demand. The system includes a number of individual distribution channels or delivery lines that are each interconnected with a number of product storage chambers within a tank. The delivery lines each collect particulate material from each of the chambers and mix the particulate materials within the lines while directing the particulate materials to different sections of the booms extending outwardly from the applicator. The individual delivery lines are interconnected with distribution lines that terminate in nozzles that dispense the particulate material onto the ground or soil over which the implement traverses. The connection between each delivery line and the associated distribution lines is made by a rotary distributor. The rotary distributor is disposed in alignment with the delivery line and includes a housing with multiple outlets that are each connected to a distribution line. The particulate material entering the horizontal rotary distributor is diverted into the distribution lines by a diverter rotatably disposed within the housing for the distributor. The diverter rotates within the housing to contact and direct the incoming particulate material into each of the distribution lines. By positioning the rotary distributor in line with the delivery line and the distribution lines, the rotary distributor eliminates the need for vertically moving the particulate material relative to the delivery lines and maintains a low or small profile when the booms formed of the delivery lines and distribution lines are moved into a folded or storage configuration.

According to another aspect of an exemplary embodiment of the invention, the diverter within the rotary distributor housing can be driven by a suitable mechanism to control the speed of rotation of the diverter. This drive mechanism enables the diverter to be operated to control the mixing of the particulate material within the rotary diverter and the diversion of the particulate material to each of the distribution lines connected to the distributor.

According to another aspect of the invention, an agricultural product delivery system includes at least one particulate material supply compartment, a number of delivery units for applying particulate material from the supply compartment, and a pneumatic conveying system providing a mixed flow of particulate material from the at least one particulate material supply compartment to the particle delivery units, the conveying system including an airflow source and a number of supply lines each operably connected to the airflow source at one end, to the at least one particulate material supply compartment and to at least one of the particle delivery units at the opposite end.

According to a further aspect of the present invention, a method of delivering a number of agricultural products from a number of compartments containing the number of products to a number of particle delivering units applying the particles in a field, including the steps of supplying the number of agricultural products from the number of compartments to the pneumatic conveying system, mixing the agricultural product in the pneumatic conveying system to form a mixed product, conveying the mixed product to the particle delivering units; metering the mixed product within the pneumatic conveying system and applying the mixed product in an agricultural field.

Numerous additional objects, aspects and advantages of the present invention will be made apparent from the following detailed description taken together with the drawing figures.

### BRIEF DESCRIPTION OF THE DRAWINGS

The drawings illustrate the best mode of practicing the present disclosure.

In the drawings:

FIG. 1 is a top plan view of an agricultural application implement, in the nature of a fertilizer spreader, having a pneumatic conveying system according to one exemplary embodiment of the invention.

FIG. 2 is a partially broken away side elevation view of a boom section of the implement of FIG. 1.

FIG. 3 is a partially broken away cross-sectional view of a rotary distributor of the pneumatic conveying system according to another exemplary embodiment of the invention.

FIG. 4 is a front plan view of the rotary distributor of FIG. 3.

FIG. 5 is an isometric view of the rotary distributor of FIG. 3 with the conical inlet housing removed according to another exemplary embodiment of the invention.

FIG. 6 is a top plan view of the outlet for the rotary distributor of FIG. 3 according to another exemplary embodiment of the invention.

FIGS. 7A-7E are isometric views of alternative diverter configurations according other exemplary embodiments of the invention.

FIG. 8 is a partially broken away perspective view of a wear resistant plate disposed on the outlet housing of the rotary distributor of FIG. 3 according to another exemplary embodiment of the invention.

FIG. 9 is a side plan view of a conical diverter configuration according to another exemplary embodiment of the invention.

FIG. 10 is an isometric view of the conical diverter configuration of FIG. 9 according to another exemplary embodiment of the invention.

### DETAILED DESCRIPTION OF THE DISCLOSURE

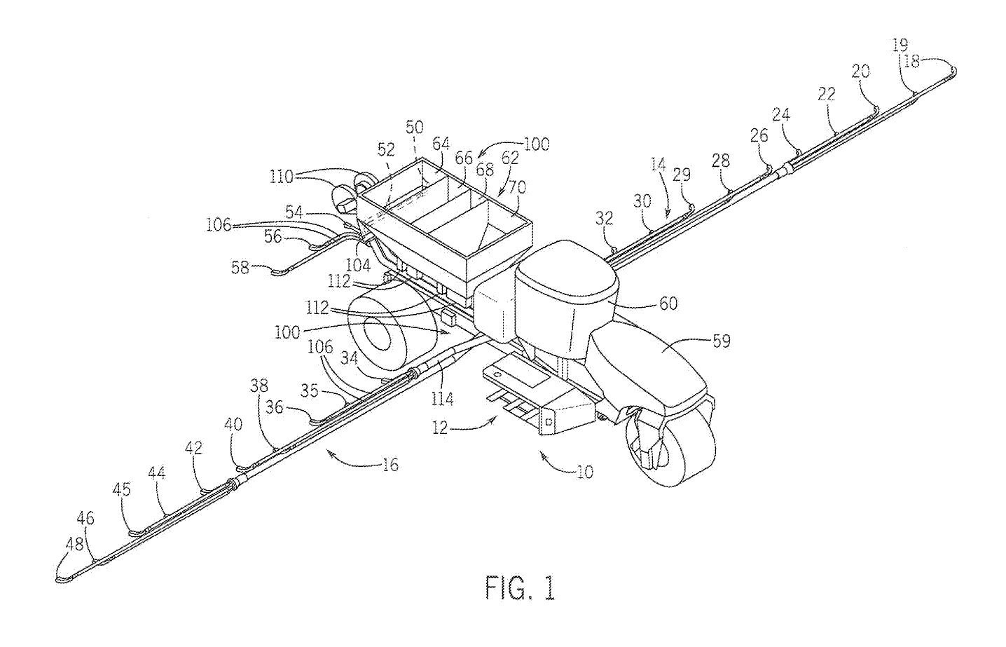

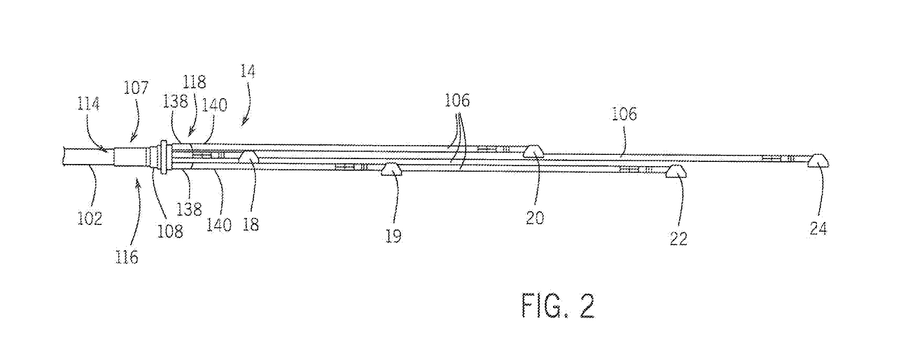

Referring now to the drawings, and more particularly to FIGS. 1 and 2, there is shown an agricultural application implement 10, on which a pneumatic conveying system 100 can be used. In the exemplary embodiment shown, application implement 10 is a granular fertilizer applicator. As is known in the art, applicator 10 generally includes a large tired transport unit 12 such as truck or tractor, which can be formed integrally or separately from the applicator 10. The applicator 10 includes laterally extending particle delivery booms 14 and 16, which may be pivoted to a stowed position close to the implement for storage or transport. Each boom 14, 16 includes a plurality of boom tubes or conduits terminating at the outboard end in a particle delivering unit, which for fertilizer applicator 10 are a spreading outlet or nozzle. In the exemplary embodiment shown, boom 14 includes ten nozzles 18, 19, 20, 22, 24, 26, 28, 29, 30 and 32; and boom 16 includes ten nozzles 34, 35, 36, 38, 40, 42, 44, 45, 46 and 48. Additionally, at the back of applicator 10 there are five rear nozzles 50, 52, 54, 56 and 58 to provide full and complete coverage across the width of implement 10, include the area between the inboard-most nozzles 18 and 34 of booms 14, 16. Implement transport unit 12 is self-propelled by an engine in an engine compartment 59 and includes an operator cab 60. In the exemplary embodiment shown, an uncovered tank 62 includes compartments 64 and 70 for carrying particulate material to be distributed to and disbursed by nozzles 18-58. Further smaller compartments 66, 68 can be provided to supply micro-nutrients or other materials to nozzles 18-58. The supply of particulate material in compartments 64, 66, 68, 70 is replenished periodically from a still larger volume supply vehicle (not shown).

Fertilizer applicator 10 is illustrative of the types of equipment for or on which the pneumatic conveying system 100 can be used; however, it should be understood that the pneumatic conveying system 100 may, of course, be employed in conjunction with other agricultural equipment such as tillage, seeding or planting devices, and is useful in distributing particulate material other than fertilizer.

Looking now at FIG. 1, in the illustrated exemplary embodiment the compartments 64-70 of the tank 62 are each disposed directly above a pneumatic conveying system or assembly 100. The system 100 includes large diameter delivery or supply lines 102 that extend from a plenum 104 at one end, under the compartments 64-70 and terminate at the booms 14, 16 or at the rear nozzles 50-58. At the booms 14, 16, the supply lines 102 and the particulate material or product A-D transported therein can be split by a suitable distribution structure or mechanism 107, such as a horizontal rotary distributor(s) 108, into a number of smaller distribution lines 106 that are connected to the nozzles 18-58.

To collect and drive the particulate material A-D along the lines 102, in the illustrated embodiment one or more pressurized air flow sources, such as fans 110 are operably connected to the plenum 104 opposite the lines 102. The air flow from the fans 110 is directed from the fans 110 through the plenum 104 and into the respective lines 102 as a result of the structure of the plenum 104. After the airflow passes through the one or more plenums 104 connected to the one or more fans 110 and collects/entrains the particulate material A-D from the compartments 64-70, such as through the use of rotary airlocks 112 interconnected between the compartments 64-70 and the lines 102, the airflow and entrained particulate material A-D continues to flow along the lines 102 to the booms 14, 16.

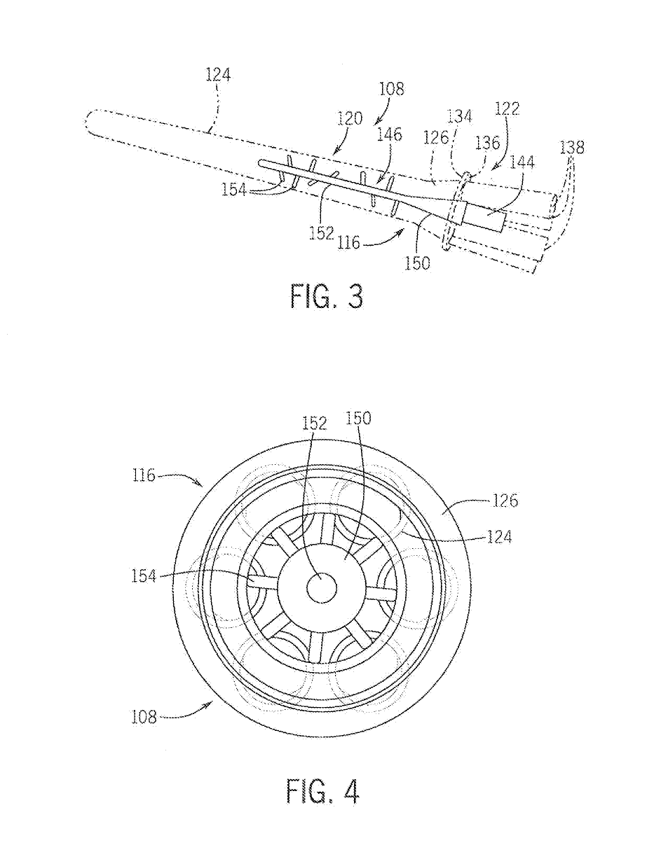

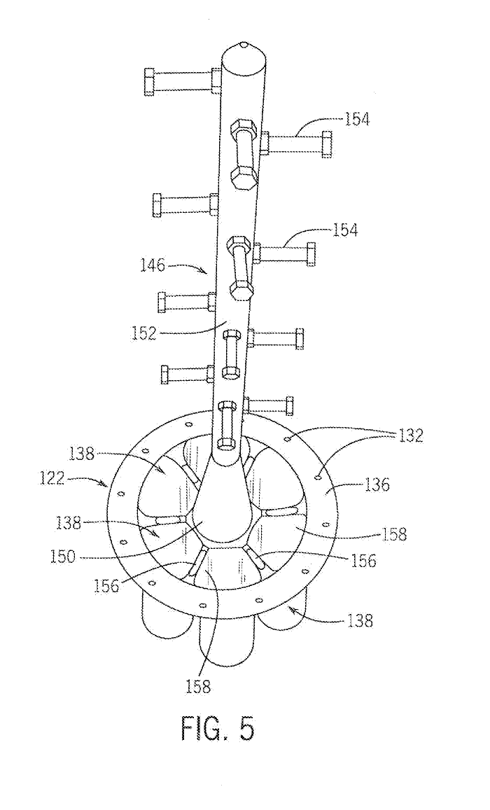

Referring now to FIGS. 2-7 an exemplary embodiment of a section of a boom 14 including the rotary distributor 108 is illustrated. The supply line 102 is connected to one end 114 of a housing 116 for the distributor 108 and the distribution lines 106 are each connected to the opposite end 118 of the housing 116. The generally tubular-shaped housing 116 is oriented in an in-line position with regard to the supply line 102, such that the housing 116 for the distributor 108 is positioned generally horizontally on the boom 14. In this position, the air flow required to urge the particulate material through the distributor 108 is greatly reduced, as little or no vertical movement of the particulate material is required, and the profile of the boom 14,16 including the distributor 108 is greatly reduced, resulting in a smaller or lower profile for the booms 14,16 when folded. The housing 116 includes a forward section 120 and a rearward section 122. The forward section 120 includes an elongate portion 124 that is engaged with the end of the supply line 102 in order to affix the housing 116 to the supply line 102 in any suitable manner. In the illustrated embodiment, the elongate portion 124 has an inner diameter greater than that of the supply line 102 such that the supply line 102 can be inserted within the elongate portion 124 and secured thereto.

Opposite the supply line 102, the elongate housing 124 is connected to or integrally formed with a conical portion 126. The conical portion 126 expands radially outwardly from the elongate housing 124 to allow the particulate material A-D entering the conical portion 126 from the elongate portion 124 to move radially outwardly from the center axis A-A of the housing 116.

The conical portion 126 is connected opposite the elongate portion 124 to the rearward section 122, such as by fasteners 128 engaged within aligned holes 130,132 in aligned radial flanges 134,136 disposed on the conical portion 126 and the rearward section 122. The rearward section 122 includes a number of outlet channels 138 that are spaced from one another on the rearward section 122 and that extend outwardly at slight angle with regard to the center axis A-A of the housing 116. The channels 138 are secured to the ends 140 of the distribution lines 106 opposite the nozzles 18-24 in a suitable manner, such as by inserting the channels 138 into the lines 106, or vice versa, and clamping the lines 106 to the channels 138 using a suitable clamping mechanism (not shown).

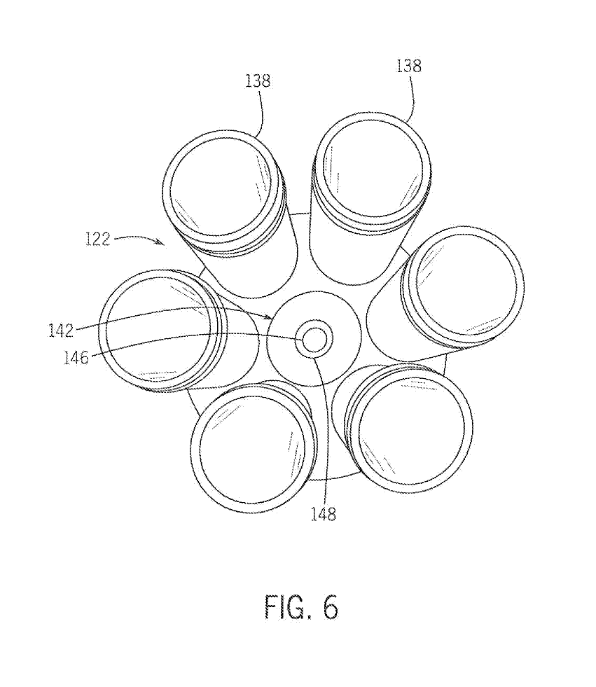

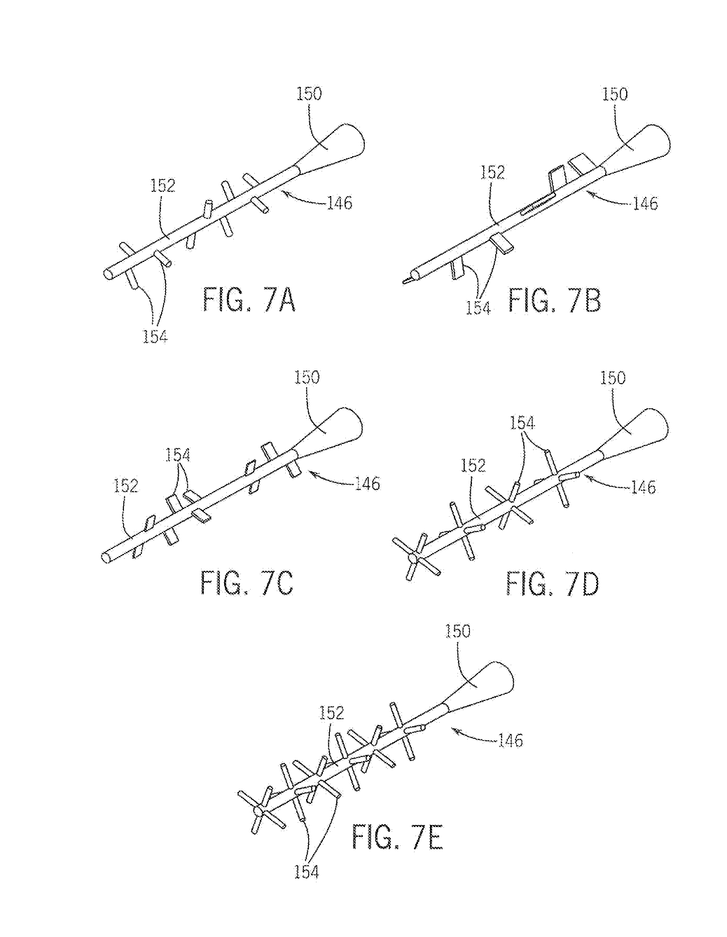

Referring now to FIGS. 2, 3, 4, 6 and 7A-7E, the channels 138 surround a space 142 on the exterior of the rearward section 122 defined between the channels 138 and in which is disposed a motor 144. The motor 144 can be an electric motor, hydraulic motor or any other suitable type of motor, and includes a shaft 146 that extends through a central aperture 148 in the rearward section 122 of the housing 116 into the interior of the housing 116. The shall 146 is aligned with or at least positioned parallel to the center axis A-A of the supply line 102, and includes a conical deflector 150 that is positioned immediately adjacent the rearward portion 122, and an elongate rod 152 that extends from the conical deflector 150 through the forward section 120 of the housing 116. The rod 152 supports a number of agitators 154 thereon, where the agitators 154 are spaced about the rod 152 at different distances from the conical deflector 150 and at different angular positions on the rod 152. Further, as shown in FIGS. 7A-7E, the agitators 154 can be positioned and formed as staggered rods (FIG. 7A), as helical paddles (FIG. 7B), as staggered paddles (FIG. 7C), or as spaced number of crosses (FIGS. 7D and 7E), among other suitable configurations for the agitators 154.

In operation, when the particulate material A-D is being directed into the housing 116 for the rotary distributor 108 by the airflow through the supply lines 102, the motor 144 is operated to rotate the shaft 146. The speed of the shaft 146 can be varied as desired and in one exemplary embodiment, can be between 200 RPM to 1000 RPM. The rotation of the shaft 146 causes the rod 152 and agitators 154 to rotate within the housing 116, with the rod 152 and agitators 154 contacting the incoming particulate material A-D. The contact of the agitators 154 with the particulate material A-D causes the particulate material A-D to be deflected outwardly from the center axis A-A of the housing 116 and into entry pathways for the channels 138. Upon entering the channels 138, the particulate materials A-D are directed into the distribution lines 106 for direction and dispensing by the nozzles 18-24. The degree of agitation or disturbance of the air flow and particulate material A-D can be varied as desired by altering one or more of the rotational speed of the shaft 146, the number of agitators 154 per cross-section and the spacing between consecutive agitators 154, such that particular configurations for the agitators 154 can be selected depending upon the types and volume of particulate materials A-D to be dispensed from the implement 10.

The rotation of the rod 152 and the agitators 154 urges the particulate materials A-D evenly around the circumference of the housing 116, such that the particulate material A-D flows relatively evenly into the channels 138 and associated distribution lines 106. Further, the conical deflector 150 assist in the direction of the particulate material A-D by redirecting or deflecting material A-D that is missed and/or not adequately deflected by the rotation of the agitators 154.

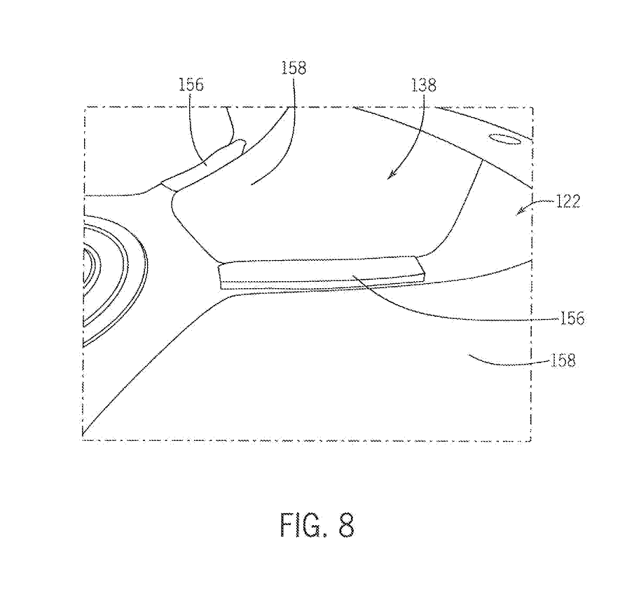

In other exemplary embodiment, as illustrated in FIG. 8, to protect the rearward section 122 of the housing 116 from damage by particulate material A-D striking the rearward section 122, protective plates 156 are placed on the areas 158 of the rearward section 122 between adjacent channels 138. The plates 156, which are formed of a high wear substance, such as carbide, protect the rearward section 122 from premature wear and failure as a result of the forces exerted by the particulate material A-D.

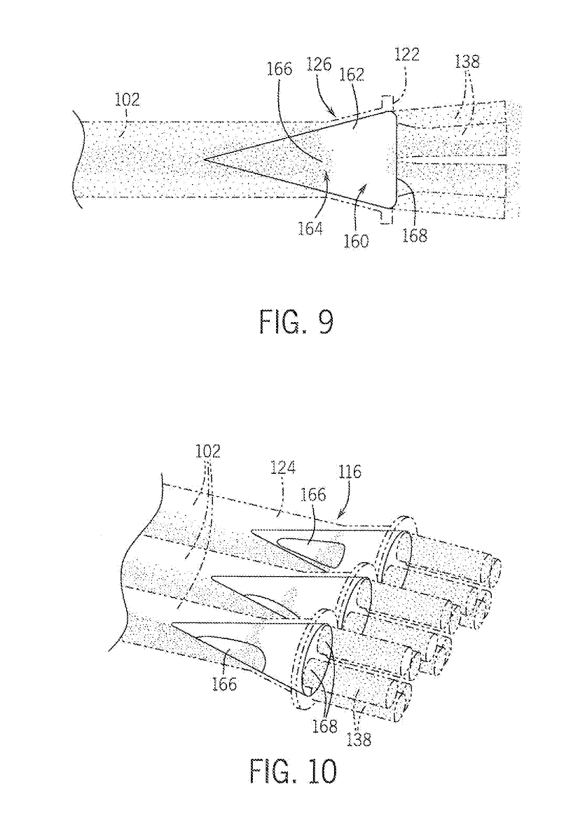

In still another exemplary embodiment illustrated in FIGS. 9-10, the rod 152 and agitators 154 can be replaced by a conical agitator 160. The conical agitator 160 includes a generally conical housing 162 that conforms closely in shape to the shape of the conical portion 126 of the housing 116 and includes a number of apertures or passages 164 spaced from one another and extending through the conical housing 162. The passages 164 are formed as recessed portions 166 disposed adjacent but spaced from the front of the conical housing 162 that direct the particulate material A-D into bores 168 extending through the conical housing 162. As the conical housing 162 is rotated by the motor 144 and shaft 146 connected between the motor 144 and the conical housing 162, the bores 168 direct the particulate material A-D into the channels 138. Additionally, the rotation of the conical housing 162 causes any particulate material A-D not initially entering the recessed portion 166 and trapped between the conical housing 162 and the conical portion 126 to be captured by a recessed portion 166 moving past the trapped material A-D such that the material A-D can enter the associated passage 164.

While the pneumatic conveying system 100 utilizing the rotary distributor 108 disclosed so far herein have been primarily with respect to fertilizer application equipment or applicator commonly referred to as a “floater”, it should be understood that the advantages from the pneumatic conveying system 100 utilizing the rotary distributor 108 disclosed herein can be obtained on other types of equipment for applying particulate materials/product in a field. Sowing implements of various types are known to include an applicator unit. such as a drill, planter or seeder, and may include an air cart having one or more bulk tanks carrying fertilizer and/or seeds to be planted.

In using a pneumatic conveying system 100 utilizing the rotary distributor 108 as disclosed herein, a variety of materials can be applied by a variety of different implements. The particulate material to be applied is contained in one or more compartments. The particulate material or materials are supplied from the tanks to the pneumatic conveying system 100 wherein the material or materials are conveyed to one or more particle injectors while being intermixed with one another. At the particle injector the conveyed product or products are distributed for dispensing from the implement 10 in a controllable and efficient manner that requires less air flow and reduces the profile of the booms 14,16 of the implement 10 for more compact and efficient storage and transport of the implement 10.

Various other alternatives are contemplated as being within the scope of the following claims particularly pointing out and distinctly claiming the subject matter regarded as the invention.

We claim:

1. An agricultural product delivery system, comprising:
at least one particulate material supply compartment;
a number of delivery units for applying particulate material from the supply compartment;
a pneumatic conveying system providing a mixed flow of particulate material from the at least one particulate material supply compartment to the particle delivery units, the conveying system comprising:
an airflow source;
a number of supply lines operably connected to the airflow source at one end, to the at least one particulate material supply compartment and to the number of delivery units at the opposite end; and
a rotary distributor connecting the supply line with the number of delivery units, wherein the rotary distributor is aligned with a center axis of the supply line; and
a metering system connected between the at least one particulate supply compartment and the pneumatic conveying system.

2. The agricultural product delivery system of claim 1, wherein the rotary distributor includes a housing having a single inlet connected to the supply line and a number of outlets connected to the number of delivery units.

3. The agricultural product delivery system of claim 2, wherein the pneumatic conveying system comprises a rotating shaft disposed within the housing and aligned with the center axis of the supply line.

4. The agricultural product delivery system of claim 3, wherein the rotating shaft comprises a conical member disposed within the housing.

5. The agricultural product delivery system of claim 4, wherein the housing includes a conical portion shaped complementary to the conical shaft.

6. The agricultural product delivery system of claim 3, wherein the rotating shaft includes a number of agitators thereon.

7. The agricultural product delivery system of claim 6, wherein the number of agitators are spaced from one another along the shaft.

8. The agricultural product delivery system of claim 7, wherein the shaft includes a conical portion spaced from the agitators.

9. The agricultural product delivery system of claim 3, further comprising a motor operably connected to the rotating shaft to rotate the shaft.

10. The agricultural product delivery system of claim 9, wherein the motor is disposed outside of the housing.

11. The agricultural product delivery system of claim 2, wherein the housing includes an elongate forward portion and a conical rearward portion.

12. The agricultural product delivery system of claim 11, wherein the conical portion defines a number of outlet channels.

13. The agricultural product delivery system of claim 12, further comprising wear plates disposed within the conical portion between the outlet channels.

14. A method of delivering a number of agricultural products from a number of compartments containing the number of products to a number of particle delivering units applying the particles in a field, comprising: supplying the number of agricultural products from the number of compartments to the pneumatic conveying system of claim 1; mixing the agricultural product in the pneumatic conveying system to form a mixed product; conveying the mixed product to a rotary distributor connected between the supply line and the delivery units; distributing the mixed product into distribution lines connected between the rotary distributor and the delivery units; and applying the mixed product in an agricultural field via the delivery units.

15. The method of claim 14, wherein the rotary distributor includes rotating shaft and wherein the step of distributing the mixed product into distribution lines comprises rotating the shaft to divert the mixed product into the distribution lines.

16. The method of claim 15, wherein the rotary distributor includes a number of agitators on the rotating shaft and wherein the step of rotating the shaft to divert the mixed product into the distribution lines comprises rotating the shaft to contact the mixed product with the agitators to divert the mixed product into the distribution lines.
